(19) United States
(12) Patent Application Publication
(10) Pub. No.: US 2015/0323369 A1
(43) Pub. Date: Nov. 12, 2015

(54) Constant Fluid Level and Equipment Monitor

(71) Applicant: MarqMetrix, Inc., Seattle, WA (US)

(72) Inventor: Brian J. Marquardt, Seattle, WA (US)

(73) Assignee: MARQMETRIX, INC., Seattle, WA (US)

(21) Appl. No.: 14/707,508

(22) Filed: May 8, 2015

Related U.S. Application Data
(60) Provisional application No. 61/991,212, filed on May 9, 2014.

(51) Int. Cl. G01F 23/00

(52) U.S. Cl. CPC G01F 23/0007; G01F 23/0069

(57) ABSTRACT

A flexible array of sensor pairs are used to monitor lubricant condition in an oiler carrying lubricant. The array of sensor pairs are placed adjacent a reservoir and detect the fluid level in the reservoir. The sensor pairs are coupled a chassis and transmit data through communications components which transmit the data to an accessible site for aggregation, monitoring and alarm features.

### CROSS-REFERENCE TO RELATED APPLICATIONS

The present application claims priority to U.S. Provisional Application No. 61/991,212, filed May 9, 2014, the content of which is incorporated herein by reference in its entirety.

### BACKGROUND

Lubrication is an aspect of maintaining machinery in proper operating condition. Machine elements such as bearings, journals, shafts, and joints require proper lubrication between their moving surfaces to decrease friction, prevent contamination, reduce wear and dissipate heat. Improper lubrication is likely to lead to premature component wear and component or system failure

When determining the optimal lubrication between moving machine elements, many factors can be considered. These factors include the operation of the machine, the type of machine element to be lubricated, the environment of the machine, the operating speed of the machine, the lubricant's viscosity, the lubricant's temperature, the lubricant's ingredients, and the lubricant's condition.

Conventional lubricators, such as the TRICO OptoMatic oiler, supply a constant level of lubricant within a lubricant reservoir to a machine element. The lubricant level is predetermined for the particular application and cannot be changed during the operating time of the machine to which the constant level lubricator is attached. Although this type of lubricator provides reasonable performance in many steady-state operations, multiple variables can create unacceptable operating conditions and lead to premature wear, or even failure, of machine elements. The variables include “on” and “off” operating modes (machine cycling), oil viscosity, machine speed, lubricant temperature, lubricant condition, and lubricant vessel pressure.

Other devices, such as the TRICO Hydrolert indicate by LED signals the status of the equipment's lubrication such as lubricant condition within acceptable levels, lubricant condition at the upper limit of acceptable levels, and lubricant condition immediate action required. This device is effective because an operator is signaled only when the lubricant condition is at the upper limit of acceptable levels or if immediate action is to be taken. This reduces maintenance costs and productivity is enhanced.

Routinely, maintenance technicians monitor industrial equipment by physical inspection. These inspections include checking fluid levels, monitoring vibrations with scopes and capturing temperature readings through infrared handheld devices.

Physical monitoring of equipment is time consuming and labor intensive. To capture such readings the maintenance technician follow prescribed routes and manually capture the data, record it and interpolate results based on a logged history.

Such maintenance systems attempt to be proactive in determining the root cause of failures. However, these types of inspection systems are not able to monitor equipment continually and inspections are done on schedules. Therefore, if equipment is not monitored routinely, the technician does not have the ability to identify equipment issues on a timely basis. Results can be catastrophic, damaging equipment and causing costly repairs. It also creates down time in production, which adds to increased costs of the failure.

Conventional ways of monitoring industrial equipment are thus currently inadequate. This is especially relevant for areas of remote access or areas that are hazardous and require special equipment to enter.

### SUMMARY

One or more embodiments of the present application enable remote monitoring of a lubricant condition over time. Specifically, failure is identified in industrial equipment caused by improper fluid levels, excess heat generation, and vibrations caused by mechanical breakdown.

The creation of one or more embodiments is based on five aspects of the entire system design that utilizes data input, data collection, data transmission, data conditioning, and data output. This device focuses on data collection and transmission in the overall design.

Several factors in monitoring equipment can signify the decay in health and longevity. By developing sensor-based technology utilizing an array of sensor components we can monitor and correlate data based on critical elements. The developed array is then transferred or arranged in a fashion to gather physical properties related to equipment lubrication. Those properties consist of fluid level, heat generation, and vibration.

Fluid level monitoring through optical sensing can predict issues with seal failure through consumption rates. Thermal monitoring by thermistor/thermocouple/IR sensor readings indicates a change in the system due to factors such as environmental or physical loads, and can be used to determine when stress is applied to equipment as well as equipment malfunction. Vibration monitoring through sound induction or accelerometer can indicate start and stop cycles, increased loading and bearing failures.

By collecting, analyzing and interpreting the data, one can use these three factors to indicate production cycle and help to predict the modes of failure. Monitoring and predicting allows response of the maintenance technician to better troubleshoot and repair equipment on a scheduled basis instead of at the time of failure.

Utilizing sensor technology, the user is able to continuously monitor equipment remotely and free labor resources. The system of the present application takes measured responses from a sensor array affixed to the constant level lubricator as a method of directly measuring the response of the piece of equipment in which it is mounted. In turn data collected from this array is sent via wireless routing to a storage area to be conditioned into usable results. The information is then transmitted using various means including web based gauges and reports, text messages via cellular based communication, email notification and/or other electronic based transmissions. Thereby, the end user is able to track equipment status and equipment issues without physically being present.

Sensors were selected based on conditions outside of the fluid zone to gather data. Some sensors may not be effective depending on the type of fluid in the fluid zone. For instance, it is preferable with reservoir materials to use dielectric resistance sensors. Also, ultrasonic transducers require submersion into the fluid medium, which may cause erosion of the sensor over time and possible contamination of the lubricant.

The inventors of the present disclosure conducted research using paired LED emitters and photodiode receivers. First the emitter was placed at the top of the reservoir and the receiver was placed at three different zones to determine signal, air zone, meniscus zone, and the fluid zone. It was found that the signals produced were not significant enough in either of the zones. Next the emitter and photodiode were place next to each other in a pair. This configuration results in a significant signal reading difference between the three different zones.

Based on the results, the paired emitter and photodiodes were affixed to the reservoir at several locations vertically along the body axis. The fluid level was then raised and lowered within the reservoir. Raising and lowering the fluid gives a clear indication of fluid level through the light response collected by each photodiode on the array. The results of all responses of the sensor/emitter pairs indicate an accurate fluid level within the reservoir.

With the complexity and different shapes of constant level lubricators, it is desired to design sensor circuitry that is flexible and can adapt to different contours and sizes of reservoirs. A flexible circuit is utilized to achieve these results by designing the circuitry with several paired sensor/emitters, controlling electronics, bluetooth transmitter and antenna, battery, thermistors, and microphone/accelerometer. Adding three thermistors to the array allows measurements to be taken from the environment and redundant temperature measurements from the constant level lubricator (thermistor and IR sensor). In turn knowing the differences of the temperatures and that thermal transmittance that is conducted through the constant level oiler, allows for conditioned responses of the data to further monitoring of the equipment. Likewise, the addition of a microphone or accelerometer can be used to indicate equipment start/stop cycles and mechanical vibrations that are not consistent with normal operation. Utilizing data gathered from the sensor array, it is possible to determine patterns and responses related to the health of the equipment. Optionally, a red indicator LED can indicate a warning of a function of the oiler.

The physical design of the embodiment consists of the sensor array, the sensor body, flexible elastomer or molded plastic assembly strap or chassis, battery compartment, and electronics compartment. The sensor array is placed into the sensor body and orientated in the vertical direction along the reservoir. The sensor body seals the sensor array, electronic components, and battery from infiltration of dirt, dust, debris, and water. The lower portion of the sensor body conforms to the base of the lubricator and straddles the top.

The fixed sensor body is molded to slide around the oil reservoir and extend along the opposite side of the reservoir to the reservoir top. The retaining strap or chassis is then stretched over the sensor body at the top of the reservoir and affixes the sensor body and array to the reservoir. Alternately, plastic molded restraining strap pieces are screwed together with the sensor gasket to fit over the sensor body. A third piece, the battery cover, completes the restraining strap. The elastomer strap also protects the reservoir from impact damage along with protecting the sensor body.

The sensor body and the strap or chassis connect together at the top of the reservoir locking the two-piece strap or chassis onto the reservoir body. The battery cover can be unsnapped and removed to change batteries. Both the sensor body and strap or chassis may be color coded for visual identification of the reservoir fluid. Electronics are able to power the array, store and transmit data wirelessly through a network utilizing smart sensing.

Primary development of the sensing array was based off of commonly utilized constant oiling equipment for industrial application. Constant level oilers maintain a predetermined fluid level in a sump, required for proper lubrication of the equipment. As the fluid level is depleted the fluid is automatically replenished to the system utilizing a reserve reservoir. This sensor array can be easily modified to be placed on a variety of different constant level lubricators or similar types of equipment providing constant fluid level having a clear or translucent reservoir body that will allow photo-detectors to read optical signals (fluorescence, Raman, IR, NIR, UV-Vis, color, absorption or scattering) through the fluid. Since constant level lubricators are normally attached to the equipment they maintain they are also good candidates to measure changes in heat caused by running conditions and vibrations translated from the equipment to the lubricator.

The sensor array is also applicable in other industrial applications such as tank fluid level indicators, reservoirs, or in any other applications where fluid level can be viewed through a clear or translucent material.

### BRIEF DESCRIPTION OF THE DRAWINGS

FIG. 1 is a perspective view of a prior art oiler comprising a glass reservoir for hosting lubricant within the reservoir, the reservoir upon which the present invention is attached;

FIGS. 2a and 2b are perspective views of different embodiments of an array of level sensor pairs carried by a flexible chassis;

FIG. 3 is a side view of an oiler with lubricating fluid in a one piece glass reservoir carrying an array of level sensor pairs;

FIG. 4 is a perspective view of a flexible chassis carrying communications components and an array of level sensor pairs;

FIG. 5 is a schematic of an embodiment of a communications system for fluid and equipment monitoring system of the present application;

FIG. 6A is a perspective view of a flexible chassis carrying communications components and an array of level sensor pairs, carried by a constant level oiler and glass reservoir, with a communications lid exposing internal communications equipment;

FIG. 6B is a perspective view of a flexible chassis carrying communications components and an array of level sensor pairs, carried by a constant level oiler and glass reservoir, with a communications lid concealing internal communications equipment;

FIG. 7A is a perspective view of an additional embodiment of a flexible chassis carrying communications components and an array of level sensor pairs, carried by a constant level oiler and glass reservoir, with a communications lid exposing internal communications equipment;

FIG. 7B is a perspective view of an additional embodiment of a flexible chassis carrying communications components and an array of level sensor pairs, carried by a constant level oiler and glass reservoir, with a communications lid concealing internal communications equipment;

FIG. 8 is a perspective view of an additional embodiment of a flexible chassis carrying communications components and an array of level sensor pairs, carried by a constant level oiler and glass reservoir;

FIG. 9 is a detailed schematic of a computing system for the fluid and equipment monitoring system of the present application;

FIG. 10 is a perspective view of an additional embodiment of a rigid enclosure carrying communication components and an array of level sensor pairs;

FIG. 11 is a cross sectional view along the centerline of the additional embodiment of FIG. 10;

FIG. 12 is a front perspective exploded view of the embodiment of FIG. 11;

FIG. 13 is a rear perspective exploded view of the embodiment of FIG. 12;

FIG. 14 is a perspective exploded view of a sensor array and mounting plate; and

FIG. 15 is a side view of an additional embodiment of the sensor array connected to a fluid level sight gauge.

### DETAILED DESCRIPTION OF THE DRAWINGS

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. §112, sixth paragraph, only if the terms “means for” or “step for” are explicitly recited in the respective limitation.

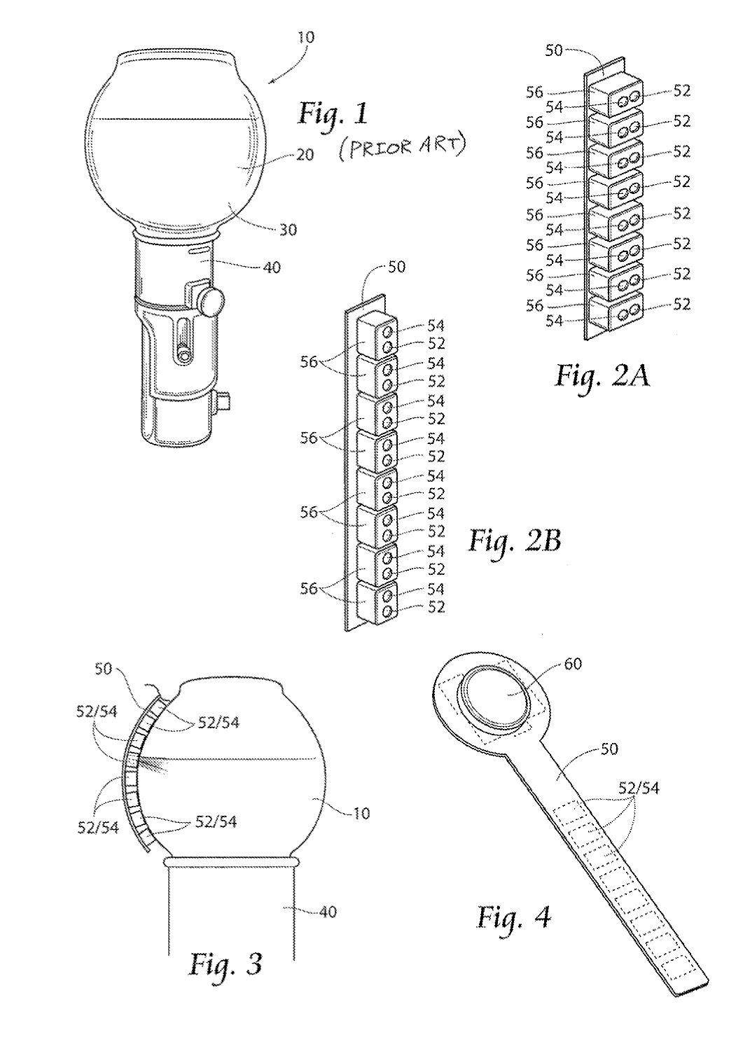

Referring now to FIG. 1, a perspective view of a typical oiler 10 comprising a glass reservoir 30 for hosting lubricant 20 within the reservoir 30 is shown. The reservoir is supported by a lower casting 40 and mounted to a targeted bearing chamber (not shown) which is supplied with lubricant 20 from the unit 10 as necessary. Components of the oiler 10 have been referenced in relation to the present disclosure and the present disclosure is an improvement in the field of oiler sensing art.

Referring now FIGS. 2A and 2B, perspective views of different embodiments of an array of level sensor pairs 52, 54 are shown carried by a flexible chassis 50. The level sensor pairs 52, 54 are further contained by a flexible block 56. The block 56 protects the level sensor pairs 52, 54 and is made of elastic rubber. It will be known to those having ordinary skill in the art that the blocks 56 may be made of any suitable material including plastic, metal, or the like and may take any shape. Although level sensor pairs 52, 54 are described throughout this specification, other sensors such as temperature sensors, accelerometers, microphones, etc. could be used in conjunction with optics to give even more information about the state of pumps and the usage rate and condition of lubricant 20. Accelerometers and microphones can detect vibrations, allowing monitoring of the ‘health’ of the pump, and temperature sensors detect overheating, allowing preemptive response to pump failure or maintenance issues. Each level sensor pair 52, 54 includes an emission sensor 52 and a collection sensor 54. One having ordinary skill in the art will understand that the emission sensor 52 and the collection sensor 54 may be any type of sensor depending on the type of sensor used, such as described above. It should also be understood that the emission sensor 52 and collection sensor 54 may be combined into the same physical unit, may include more than two sensors, or the like. Hydrocarbon or pump oils such as lubricant 20 of FIG. 1 absorb and/or scatter UV-Visible (UV-Vis), infrared (IR) or near infrared (NIR) light very efficiently. The interface between the oil and air can be found by placing an array of level sensor pairs 52, 54 up and down the side of a transparent oil vessel when illuminated with various wavelengths of light and comparing the amount of signal light collected. A small quantity of light will be collected by the level sensor pairs 52, 54 from the oil, due to a large portion of the excitation light being altered, absorbed, and/or scattered by the oil. Alternatively, the air above the oil will allow the level sensor pairs 52, 54 to collect a large/small quantity of light, because the air does not absorb and/or scatter light. Preferably the level sensor pairs 52, 54 include a simplified sensor using paired LEDs and photodiodes. It has been found that level sensor pairs 52, 54 can effectively measure oil level with significant change in signal between air and oil 20 contained in the reservoir 30. The difference between the vertical pairs of level sensor pairs 52, 54 then signals the lubricant 20 level in the reservoir 30. For instance, typical response of level sensor pairs 52, 54 to air only is from a much higher voltage than response to oil 20.

In order to enhance the capabilities of the glass reservoir 30 from FIG. 1, one can greatly lower the surface tension of the glass-oil interface, an “oleophobic” (literally “oil-hating”) coating can be created. A surface modifier is applied and chemically bound to the glass 30 to accomplish this. Such coatings cause strong repulsion of the oil 20 from the glass 30, preventing oil 20 from sticking to the surface of the glass 30 and allowing easy runoff and ‘self-cleaning’ properties. This is especially important as oil 20 ages and leaves sticky residues on the glass 20. Such residues could greatly inhibit sensor 52, 54 performance by absorbing light above the oil-level, thus causing false oil-level data to be gathered. The repulsion effect causes oil to immediately slide down the side of the glass 30 in a sheet rather than slowly sliding down or sticking. This mitigates effects of changes in oil-level, as well as any bubbles arising from pressure buildup, which could spray oil onto the sides of the vessel, both of which inhibit accurate measurements.

Referring still to FIGS. 2A and 2B, FIG. 2B shows an “In-Line” orientation of level sensor pairs 52, 54 that requires fewer LED's and allows one LED to excite two detectors, yielding more information per LED pulse, and FIG. 2A shows “Side-by-Side” level sensor pairs 52, 54 along a horizontal plane with an LED with each detector for higher signal-to-noise and sensitivity.

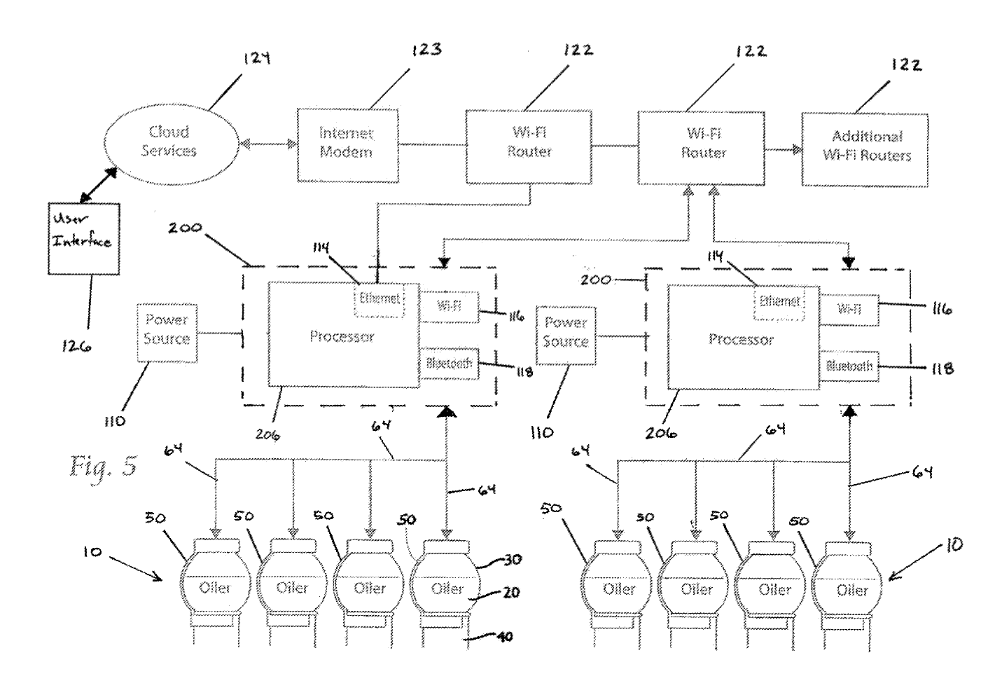

Referring now to FIG. 3, a side view of an oiler 10 with lubricating fluid 20 in a one piece glass reservoir 30 is shown carrying an array of level sensor pairs carried by flexible chassis 50. Chassis 50 is designed to conform when desired to the shape of the external shape of the reservoir 30. Chassis 50 can be configured as shown in FIG. 4 to carry a lid 60 having communications components 64 placed inside. Lid 60 can be placed in a void space atop reservoir 30 (depending on the configuration of the reservoir) and removed when it is desired to add lubricant 20 to the reservoir 30.

Referring now to FIG. 5, a systems schematic for the fluid and equipment monitoring system of the present disclosure is shown. An array of chassis 50 systems carrying level sensor pairs 52, 54 are carried by a series of oiler units 10 carrying lubricant 20 in reservoir 30. The level sensor pairs 52, 54 communicate with processors (e.g., through Bluetooth low energy) for communication. Other types of communication networks and protocols can also be used, such as ZigBee, eNet, Wi-Fi, and thus the various embodiments herein should not be considered limited to any particular network or protocol. A processor communicates with routers, a modem and ultimately cloud services and the internet for data retrieval and analysis. A user interface can then be accessed remotely to provide an end user with the data collected by the array.

Referring now to FIG. 9 a system diagram of an exemplary embodiment of a computing system 200 for monitoring fluid levels and equipment monitors is illustrated. The computing system 200 is generally includes a processing system 206, storage system 204, software 202, communication interface 208 and a user interface 210. The processing system 206 loads and executes software 202 from the storage system 204, including a software module 230. When executed by the computing system 200, software module 230 directs the processing system 206 to operate as described in herein in further detail.

Although the computing system 200 as depicted in FIG. 9 includes one software module in the present example, it should be understood that one or more modules could provide the same operation. Similarly, while description as provided herein refers to a computing system 200 and a processing system/processor 206, it is to be recognized that implementations of such systems can be performed using one or more processors, which may be communicatively connected, and such implementations are considered to be within the scope of the description.

The processing system/processor 206 can include a microprocessor and other circuitry that retrieves and executes software 202 from storage system 204. Processing system/processor 206, can be implemented within a single processing device but can also be distributed across multiple processing devices or sub-systems that cooperate in executing program instructions. Examples of processing system/processor 206 include general purpose central processing units, application specific processors, and logic devices, as well as any other type of processing devices, combinations of processing devices, or variations thereof.

The storage system 204 can include any storage media readable by processing system 206, and capable of storing software 202. The storage system 204 can include volatile and non-volatile, removable and non-removable media implemented in any method or technology for storage of information, such as computer readable instructions, data structures, program modules, or other data. Storage system 204 can be implemented as a single storage device but may also be implemented across multiple storage devices or sub-systems. Storage system 204 can further include additional elements, such a controller capable of communicating with the processing system 206.

Examples of storage media include random access memory, read only memory, magnetic discs, optical discs, flash memory, virtual and non-virtual memory, magnetic sets, magnetic tape, magnetic disc storage or other magnetic storage devices, or any other medium which can be used to store the desired information and that may be accessed by an instruction execution system, as well as any combination or variation thereof, or any other type of storage medium. In some implementations, the storage media can be a non-transitory storage media.

User interface 210 can include a mouse, a keyboard, a voice input device, a touch input device for receiving a gesture from a user, a motion input device for detecting non-touch gestures and other motions by a user, Ethernet ports, and other comparable input devices and associated processing elements capable of receiving user input from a user. In embodiments, the user interface 210 operates to present and/or to receive information to/from a user of the computing system 200. Output devices such as a video display or graphical display can display an interface further associated with embodiments of the system and method as disclosed herein. Speakers, printers, haptic devices and other types of output devices may also be included in the user interface 210.

As described in further detail herein, the computing system 200 receives and transmits data through the communication interface 208. In embodiments, the communication interface 208 operates to send and/or receive data to/from other devices to which the computing system 2001 is communicatively connected. In the computing system 200, sensor data 220 is received. The sensor data 220 may exemplarily come directly from a plurality of sensors while in other embodiments the sensor data 220 can be stored at a computer readable medium which may be remotely located form the computing system. In a still further embodiment, the sensor data 220 can be received by the computing system 200 from an intermediate computer (not depicted) that performs processing on the data, As described above, the computing system 200 can also receive management data 240, time data 250, schedule data 260, and maintenance 270 which is all exemplarily stored on one or more computer readable media. The computing system 200 can executes application module 230 to carry out an embodiment of the disclosure described herein.

The computing system 200 processes the sensor data 220 in order to identify, count, and/or track fluid characteristics in the sensor data 220. The computing system further receives management data 240, time data 250, schedule data 260, and maintenance data 270 and uses this information to determine interaction evaluations 290 as described above. The interaction evaluations 290 can be sent by the communication interface 208 to one or more remote computing devices, exemplarily one associated with a manager. The computing system 200 also may output the interaction evaluations 290 on a graphical display or other output device of the user interface 210. The interaction evaluations 290 may be used by a manager or other personnel to evaluate store operation and to exemplarily modify the sensor data.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

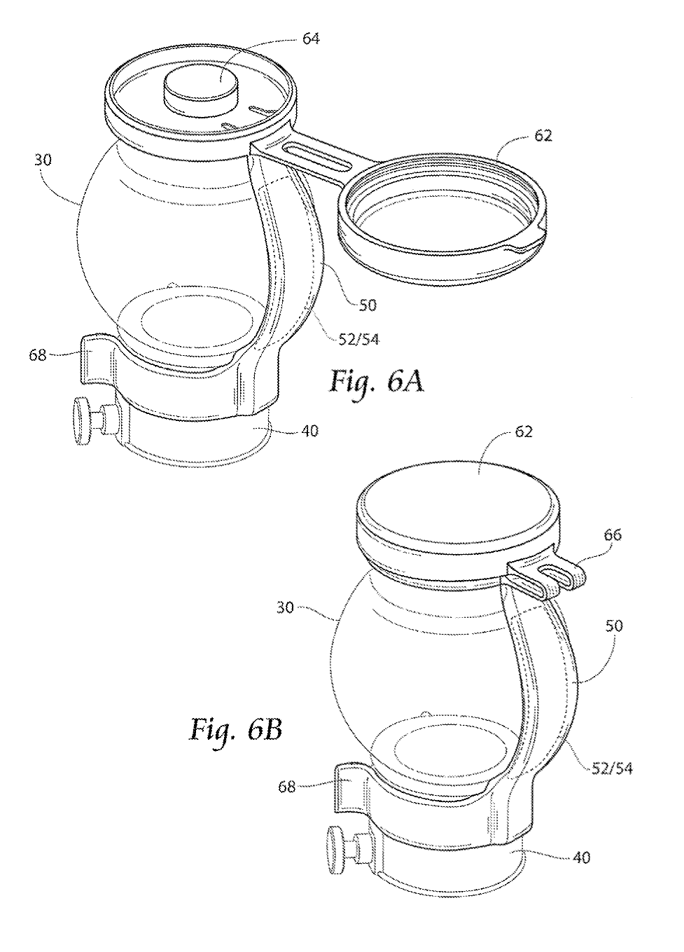

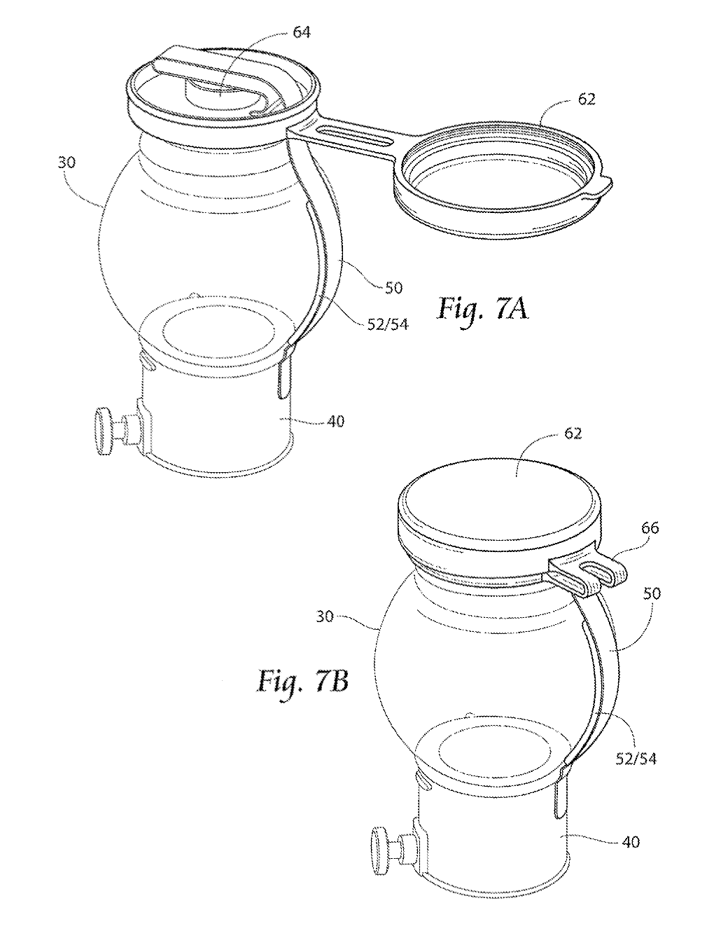

Referring now to FIG. 6A, a perspective view of a flexible chassis 50 carrying communications components 64 and an array of level sensor pairs 52, 54 is shown. The chassis 50 is designed as a flex circuit adjustable pigtail carrying level sensor pairs 52, 54, which are coupled to and communicate with communications components 64 as shown in FIG. 7A, with chassis 50 extending into and coupled with the communications components 64 within the housing created by the flip lid 62. The level sensor pairs 52, 54 face the glass, and a thermal sensor can be applied to housing 40. Communications components 64 can comprise flex circuit components, a Bluetooth antenna implemented in traces around a perimeter of a top surface of component 64, and a battery can be housed in this area between communication components 64 and integral hinging and sealing snap lid 62 with hinge 66. Snap lid 62 is shown in an open condition in FIG. 6A and in a closed condition in FIG. 6B. Clamp or spring clip 68 can be used to secure the array 52, 54 and chassis 50 to reservoir 30 and housing 40.

In this embodiment snap lid 62 provides waterproof enclosure for communications components 64, and the associated battery and electronics are protected from the external environment while allowing easy access for battery change.

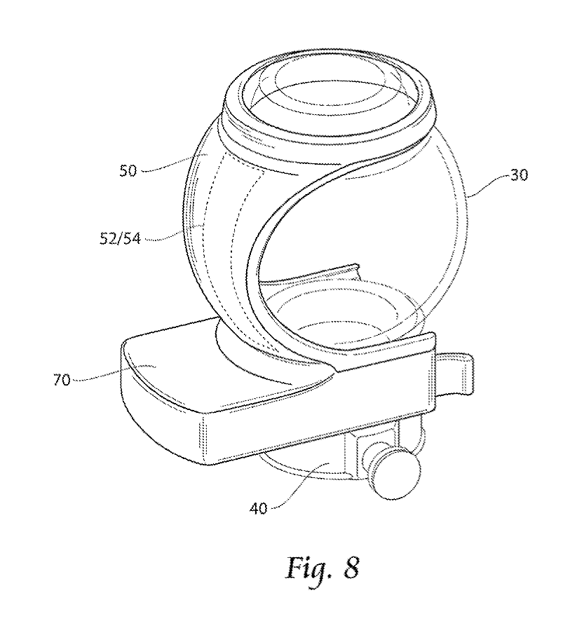

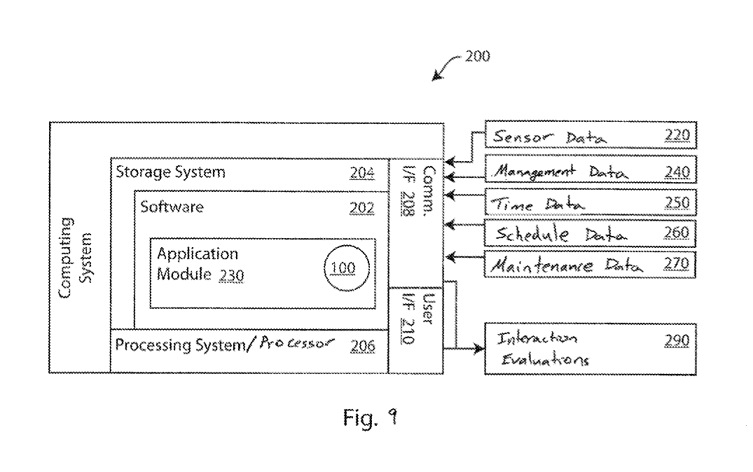

Referring now to FIG. 8, a wrap around embodiment of the oil level sensor is shown. Sensor pairs 52/54 are side mounted and carried by flexible chassis 50 and coupled with enclosure 70, which houses the electronics, battery and antenna (not shown). Enclosure 70, preferably waterproof, keeps the oiler 10 top open and free of obstructions. This secure “snap-fit” design is easily retrofitted to oilers of different shapes and sizes. In a preferred embodiment, chassis 50 and enclosure 70 can be formed of or carry a tensioned elastomer which stretches and causes tension to hold the device in place about the reservoir 30 and to keep the sensor pairs 52/54 in their optimal position tight against glass reservoir 30. These components of 50 also can be made of preformed plastic that clasp housing 40 through pressure. Alternatively, the elements can be formed of a combination of an elastomer for flexibility and a preformed plastic as desired.

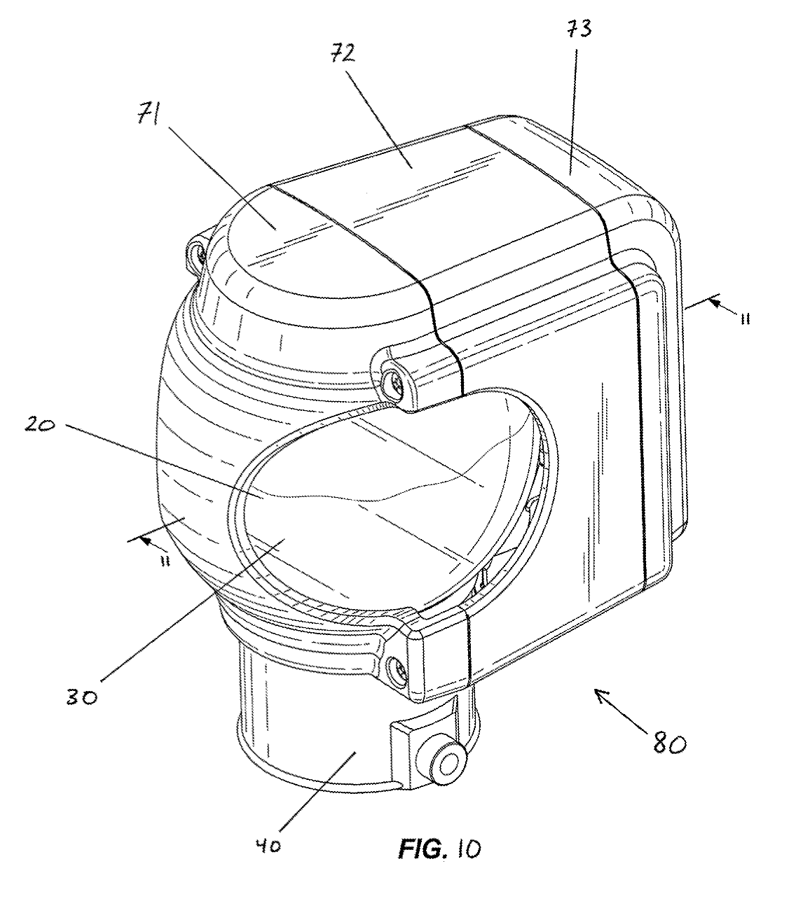

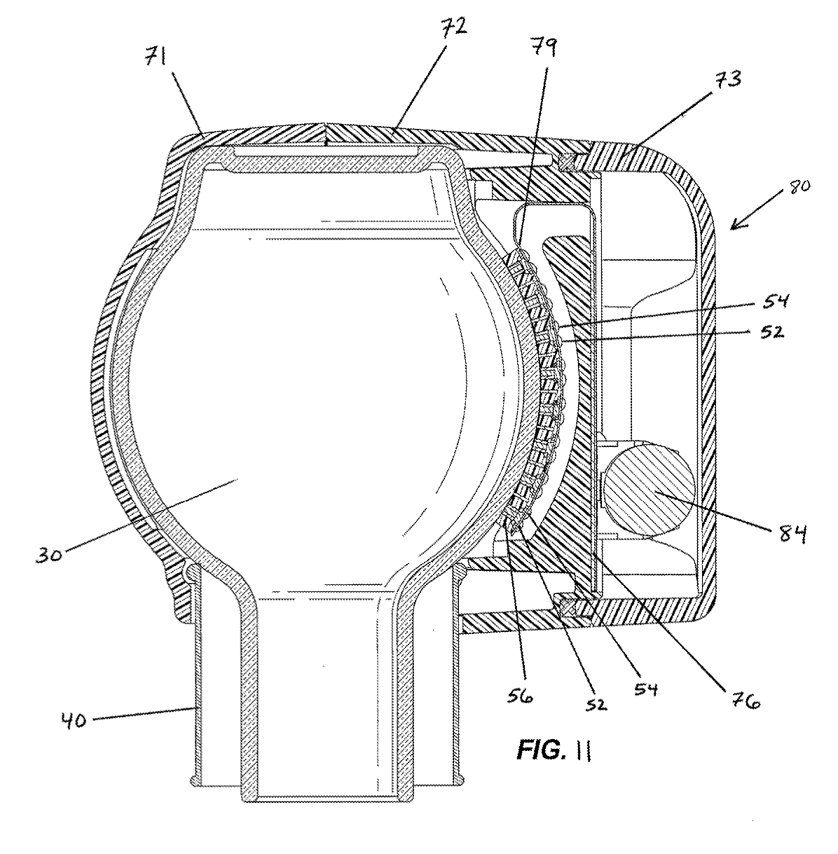

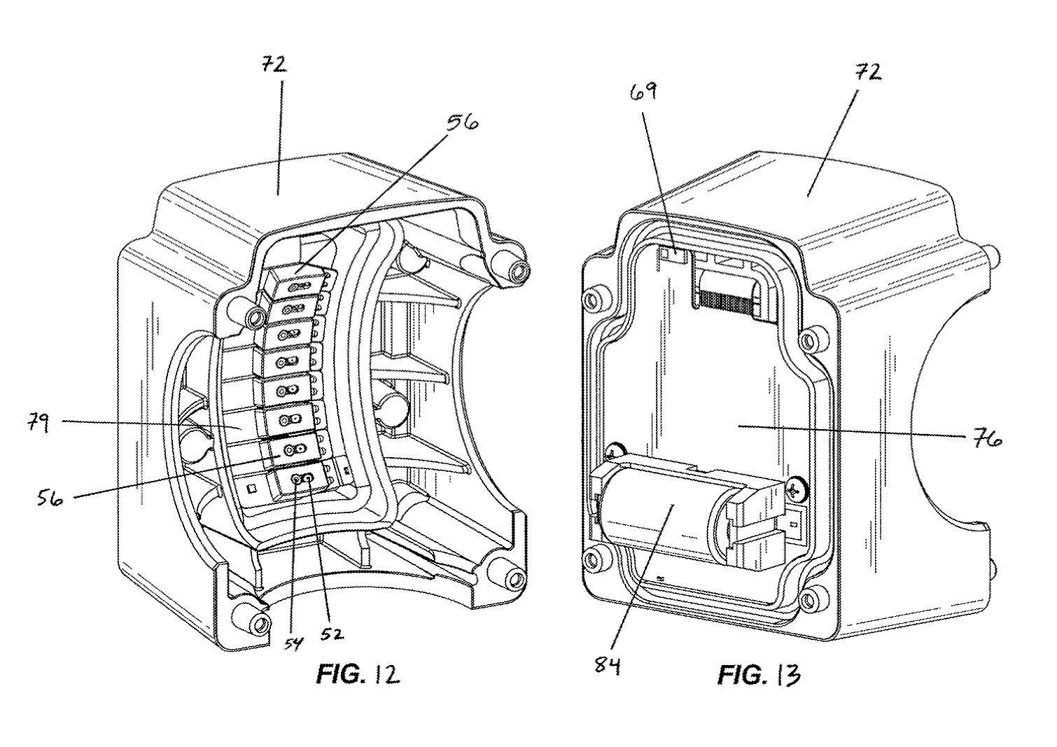

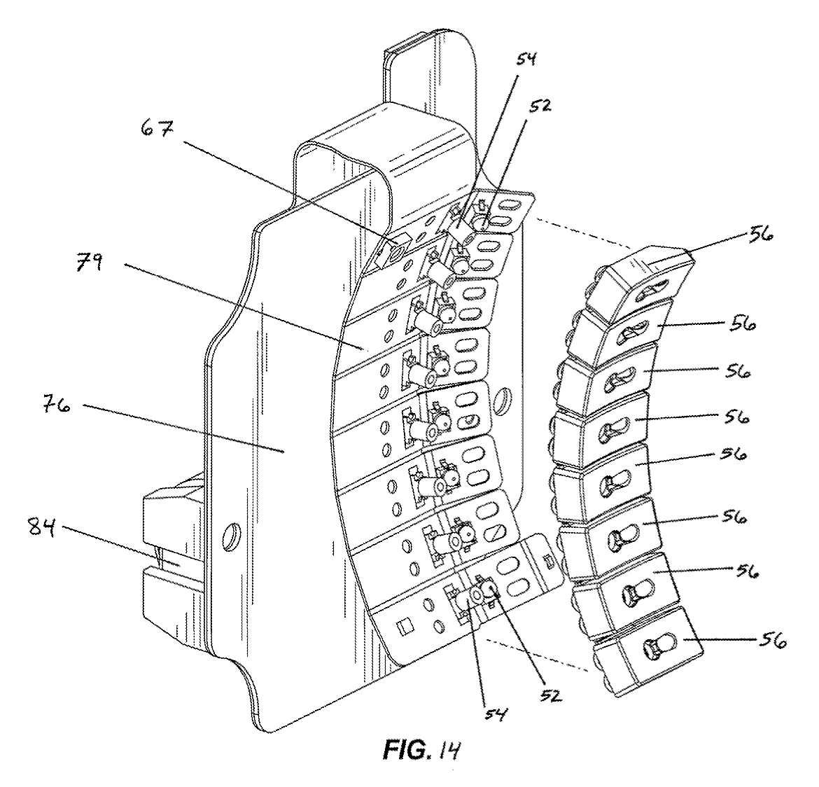

Referring now to FIGS. 10-14, an alternative embodiment of the array of level sensor pairs 52, 54 which are carried on a rigid sensor body 80. The sensor body 80 connects to the oiler 10 by engaging with the glass 30. The sensor body 80 of the alternative embodiment includes a first portion 71, a second portion 72, and a third portion 73. A BTLE radio can be used as a communication component 69. The sensor body 80 is generally rectangular and may include a void or hole to accommodate the shape of the glass 30 and provide a visual inspection point. It should be known to those having ordinary skill in the art that the sensor body 80 may comprise a plurality of portions and take any shape. When installed on an oiler 10, the first portion 71 is placed on the glass 30 and the second portion 72 is connected with the first portion 71. The first portion 71 and the second portion 72 may be connected by screws, bolts, slideable connections, frictional engagement, and/or the like. The third portion 73 is also connected to the second portion 72. The sensor body 80 is made out of rigid plastic, however the sensor body 80 may be constructed out of any suitable material including metal, rubber, or the like. A chassis 76 is connected to the second portion 72.

In an additional embodiment, the second portion 72 including a cut-out or hole which allows the chassis 76 to be connected to the second portion 72. The array of level sensor pairs 52, 54 and blocks 56 are connected to the sensor board 79.

In operation, the sensor body 80 is connected to the oiler 10 and the blocks 56 contact with the glass 30 of the oiler 10. The contact of the blocks 56 to the glass 30 causes the blocks 56 to elastically deform. The sensor pairs 52, 54 which are located in the blocks 56 receive and/or transmit signals which are altered, scattered, and/or absorbed as a signal interacts with the fluid. The signal may be emitted by emission sensors 52 or other components. The signals may be electrical, audible, thermal, and/or the like. Collection sensors 54 receive the altered signals and transfer the signal data, as described above.

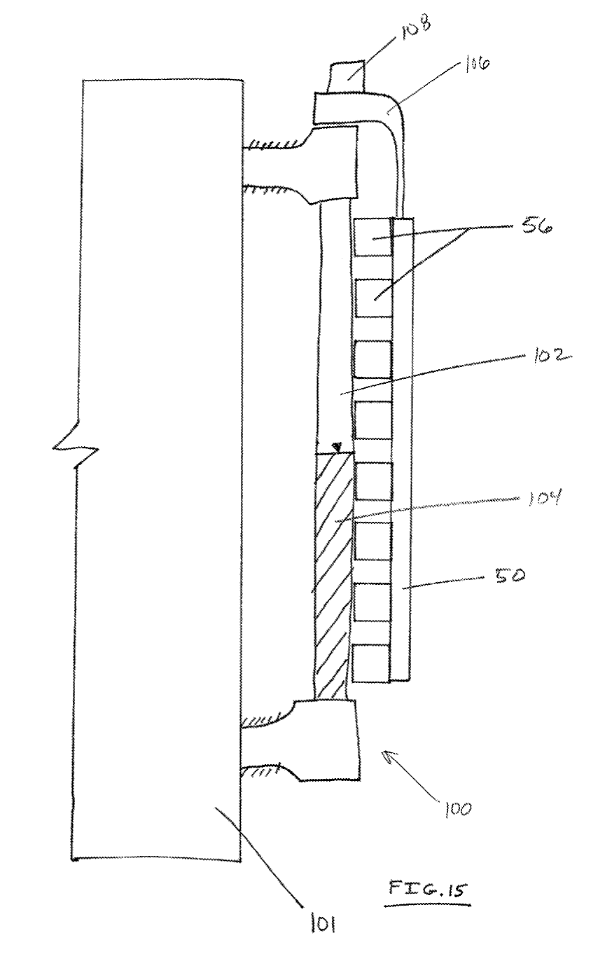

Turning now to FIG. 14, an exploded view of the chassis 76 is shown. The chassis 76 includes a sensor board 79. The sensor board 79 includes various holes for connecting emission sensors 52, collection sensors 54, blocks 56, communication components 69, and/or other components. Also, the sensor board 79 may include embedded circuitry to connect components to one another electrically. In one non-limiting embodiment, sensor board 79 is shaped to fit into second portion 72, but not shaped to the glass ball, while chassis 76 can be shaped to the glass ball. In another embodiment, the sensor board 79 can shaped similar to the curvature and/or shape of the glass 30. It should be known to those having ordinary skill in the art that the sensor board 79 may take any shape and may be moldable and/or elastically malleable to conform to various glass 30 shapes.

Once connected to the sensor board 79, the array of level sensor pairs 52, 54 are electrically connected to an indicator light emitting LED 67 used as an indicator of a warning condition determined for the oiler. The connection can be by direct electrical connections either integral with the sensor board 79 or by being connected to the sensor board 79. The communication components 69 transmit the data to the computing system 200. A power source 84 is connected to the chassis 76. The power source 84 provides power to the various sensors on the chassis 76, and the power source 84 may be a battery, AC connection, DC connection, or the like. Referring back to FIG. 13, the third portion 73 is removably connected to the second portion 72. The third portion protects the chassis 76 and power source 84 and allows a user to easily inspect the chassis 76, replace the power source 84, and/or adjust parameters of the chassis 76.

FIG. 15 depicts an additional alternative embodiment of the array of level sensor pairs 52, 54 is shown on a fluid level gauge 100 which is connected to a drum 101 containing a fluid. In this embodiment, the array of level sensor pairs (not shown) is similar to those shown in FIGS. 2A-2B. The level sensor pairs are located in blocks 56, and the blocks 56 are pressed up against the visual inspection sight tube 102 of the sight gauge 100. In this orientation, the sensors read the fluid level signals altered by the fluid 104 to determine the fluid level. Flexible chassis 106 is similar to the other chassis described above and carries the various circuitry and communication component 69 of the array of level sensor pairs 52, 54. The assembly also includes a power source 108 attached to the chassis 106 as described above.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

We claim:

1. An automatic fluid level monitoring system that determines a fluid level in a reservoir, comprising:
a chassis;
a sensor array including a plurality of sensors, the plurality of sensors are positioned adjacent to the reservoir and receive signals altered by a fluid level in the reservoir;
a communication component operative to communicate signal data, generated based on the signals, representing the fluid level in the reservoir; and
a power source operatively providing electrical power to the plurality of sensors and the communication component.

2. The automatic fluid level monitor system of claim 1, wherein the plurality of sensors comprises optical, light emitting diode (LED) emitters, photodiode receivers, thermal, vibratory, audible transmitters or thermal, vibratory, audible receivers.

3. The automatic fluid level monitor system of claim 1, wherein the optical, light emitting diode (LED) emitters emit light in at least one of an infrared wavelength range, an ultraviolet-visible wavelength range, or a near infrared wavelength range.

4. The automatic fluid level monitor system of claim 1, wherein the plurality of sensors is arranged in pairs.

5. The automatic fluid level monitor system of claim 4, wherein each pair of the pairs of the plurality of sensors includes an emission sensor and a collection sensor, wherein the emission sensor emits a signal and wherein the collection sensor receives the signal altered by the fluid level.

6. The automatic fluid level monitor system of claim 4, wherein the pair of the pairs of the plurality of sensors are arranged on a horizontal plane.

7. The automatic fluid level monitor system of claim 1, further comprising:
a computing system,
wherein the computing system receives data from the communication component and determines the fluid level.

8. The automatic fluid level monitor system of claim 1, further comprising:
a plurality of blocks connected to the chassis,
wherein the plurality of sensors is positioned in the plurality of blocks, and wherein the plurality of blocks is positioned adjacent to the reservoir.

9. The automatic fluid level monitor system of claim 1, further comprising:
a hinge including a lid,
wherein the hinge is connected to the chassis and wherein the lid is connected to the reservoir.

10. The automatic fluid level monitor system of claim 1, further comprising:
an oleophobic coating,
wherein the oleophobic coating is applied to the reservoir.

11. The automatic fluid level monitor system of claim 1, further comprising:
a sensor body including a plurality of portions,
wherein the sensor body is connected to the reservoir and wherein the chassis is attached to the sensor body.

12. The automatic fluid level monitor system of claim 1, further comprising:
an indicator light emitting diode (LED) used as an indicator of a warning condition determined by the automatic fluid level monitor system.

13. The automatic fluid level monitor system of claim 1, wherein the signals comprise a signal that encodes information representative of at least one of temperature data representing a temperature of the reservoir, a vibration of the reservoir, a color of the reservoir, a light scattering of the reservoir, and particle data representative of a number or type of particles in the reservoir.

14. A method of measuring the fluid level in a reservoir, comprising:
placing a sensor array adjacent to the reservoir; and
using a communication component, transmitting data from a plurality of sensors of the sensor array including a plurality of sensors that are connected to a chassis,
wherein the chassis is connected to a power source and to the sensor array, and wherein the communication component is connected to the sensor array.

15. The method of claim 14, further comprising:
computing the fluid level in the reservoir in response to the transmitting the data.

16. The method of claim 14, wherein the plurality of sensors comprises optical, light emitting diode (LED) emitters, photodiode receivers, thermal, vibratory, audible transmitters or thermal, vibratory, audible receivers.

17. The method of claim 14, further comprising:
emitting light from the optical, light emitting diode (LED) emitters emit in at least one of an infrared wavelength range, an ultraviolet-visible wavelength range, or a near infrared wavelength range.

18. The method of claim 14, further comprising:
emitting light from an indicator light emitting diode (LED) used as an indicator of a warning condition relating to the reservoir.

19. The method of claim 14, wherein the data comprises information representative of at least one of temperature data representing a temperature of the reservoir, a vibration of the reservoir, a color of the reservoir, a light scattering of the reservoir, or particle data representative of a number or a type of particles in the reservoir.

20. A system, comprising:
chassis means for supporting a reservoir in which a fluid level is to be measured;
sensor means, positioned adjacent to the reservoir, for and measuring the fluid level of the reservoir and for obtaining signals representative of the fluid level in the reservoir;
communication means for communicating the signals or information based on the signals; and
power means for generating power for the sensor means and the communication means.
